(19) United States
(12) Patent Application Publication
(10) Pub. No.: US 2023/0086758 A1
(43) Pub. Date: Mar. 23, 2023

(54) CONTAINER SEALING APPARATUS AND METHOD OF SEALING

(71) Applicant: ISHIDA EUROPE LIMITED, Bimingham West Midlands (GB)

(72) Inventors: David MORGAN, Bournemouth Dorset (GB); Lee VINE, Poole Dorset (GB)

(21) Appl. No.: 17/795,348

(22) PCT Filed: Jan. 27, 2021
(86) PCT No.: PCT/GB2021/050186

§ 371 Date: Jul. 26, 2022

(30) Foreign Application Priority Data
Jan. 27, 2020 (GB) 2001133.4

(51) Int. Cl. B65B 7/16; B65B 51/14; B65B 57/02; B65B 61/06

(52) U.S. Cl. CPC B65B 7/164; B65B 51/14; B65B 57/02; B65B 61/06

(57) ABSTRACT

There is provided container sealing apparatuses and methods for sealing openings of containers with film. The apparatuses comprise: a pressing member configured to press a film into contact with a container; and a sealing beam source configured to emit one or more sealing beams, each of said sealing beams being incident on the container and/or the film, each of said sealing beams being incident local to a respective part of the pressing member which engages the container so as to join the film to the container; the container sealing apparatus being configured to move the container relative to the pressing member, such that a region of the container which is engaged by the pressing member changes.

### FIELD OF INVENTION

The invention relates to a container sealing apparatus for sealing a film to openings of containers, and a method performed using such an apparatus. In this context the term “container” includes any container having an upwardly facing opening to which a film is to be sealed (commonly termed “trays”).

In particular, the invention provides an apparatus which is able to quickly and efficiently seal containers and which offers a high throughput of sealed containers. These apparatuses and methods are particularly well suited for use in the food packaging industry.

### BACKGROUND

It is common in the food industry to package food items in sealed containers.

For instance, traditionally many food items are packaged in heat sealed trays, particularly for fresh fruit and other fresh food items. In one conventional apparatus, trays are filled with food items and then supplied, typically in groups, to a tray sealer having a heat sealing tool. The heat sealing tool has a lower tool part on which the tray(s) to be sealed are positioned, and an upper tool part typically comprising a contoured heated element or plate. The lower tool half and the upper tool part are brought together with a heat sealable film between the tray(s) and the upper tool part, such that the upper tool part is brought into engagement with the heat sealable film and the edge of each tray so as to heat seal the film to the tray(s). The sealed tray(s) are then removed from the tray sealer.

Although such an apparatus and process may produce an effective seal, there are a number of significant disadvantages.

For instance, heating the upper tool half is expensive, involving large amounts of energy.

In addition, the surface that surrounds an opening of a container is rarely flat or planar. To ensure an effective seal around the full perimeter of the openings in trays the upper tool half and lower tool half must be pressed together using excessive force (in some cases greater than 10 kN). This force flattens the surface of tray(s), ensuring that the entire perimeter of opening(s) is engaged by the heated element and sealed using the film. The high forces required again mean that the process uses large amounts of energy, and the apparatus expensive to use.

Furthermore, the tool parts of the sealing tool must be specifically designed and machined to suit the specific trays or containers to be sealed. Contours of the heated element or plate must match the perimeter of the opening(s) to be sealed. Designing and machining the tools is slow and expensive, and the final apparatus is inflexible since it cannot be adapted for use with containers having an alternative size or shape.

In addition, although a single sealing tool may seal multiple trays or containers in each operation the process is relatively slow. Sufficient dwell time must be provided during which the tray(s) are engaged by the sealing apparatus to ensure that sufficient heat is transferred to the film to create an effective seal.

Therefore, there is a desire, especially in the food packaging industry, to provide improved means of sealing containers which overcome at least some of the disadvantages discussed above.

### SUMMARY OF INVENTION

In place of the conventional sealing apparatuses discussed above, the inventors have recognised that films may be joined to containers by applying energy to a film using lasers or other sealing beams.

Such a non-contact heating step avoids the need for the extreme temperatures and pressures applied using traditional methods, reducing energy consumption. Furthermore, the apparatus may be easily modified to accommodate containers of different types, dimensions and shapes. In addition, the ability to join or bond a film to a container during continuous motion of the container (i.e. as part of an “in-line” process) has the potential to significantly improve throughput.

However, the inventors have also recognised that achieving effective seals around container openings (e.g. an airtight, gastight, watertight and/or liquid-tight seal) is not trivial. In the food packaging industry such gastight and liquid tight seals are often necessary to avoid spoilage or loss of packaged food products packaged in a container.

As discussed above, containers which reach a sealing apparatus are often imperfectly or inconsistently shaped (e.g. due to manufacturing tolerances or damage during transport). Consequently, the surface in which an opening is formed may not be uniform or planar.

An example of a container is shown in FIGS. 1a, 1b and 1c. Specifically, these figures respectively show a cross section, plan view and projection view of a tray 1 with a rim 2. The tray 1 is concave or dish shaped, defining an internal volume 6 within which a food product (for example) may be stored. The internal volume 6 is accessed via an opening 4, the opening 4 being surrounded by the rim 2 and being upward facing (as shown).

This tray 1 has an exaggerated imperfection. As will be seen, the rim 2 is not planar and instead has a concave shape, the tray 1 being taller at its sides than at its centre.

When a film 8 is applied across the opening 4 of such a tray 1—as shown in FIG. 1c—the film 8 will not contact the rim 2 of the at all points around the perimeter of the opening 4. Instead a gap G exists between the film 8 and the rim 2 at points around the perimeter of the opening. If a sealing beam such as a laser is applied to the rim 2 and/or film 8 around the perimeter of the opening 4, the film 8 will not be joined to the tray 1 at all points and the opening 4 will not be effectively sealed. As such, gas or liquid may enter and/or exit the internal volume 6 potentially causing loss or spoilage of a foodstuff, article or other product contained therein.

It is noted that this problem is not solved by stretching the film 8 taut across the opening 4, for instance, by raising the tray 1 into contact with the film 8 as shown in FIG. 1c. There remains a gap G between the film 8 at some points around the perimeter of the opening 4 (e.g. between the lower portions of the rim 2 and the film 8 as shown).

Consequently, a method of sealing containers using laser beams or other sealing beams which successfully overcomes the disadvantages discussed above has not previously been developed.

In accordance with a first aspect of the invention there is provided a container sealing apparatus for sealing openings of containers with film, the container sealing apparatus comprising:
a pressing member configured to press a film into contact with a container; and
a sealing beam source configured to emit one or more sealing beams, each of said sealing beams being incident on the container and/or the film, each of said sealing beams being incident local to a respective part of the pressing member which engages the container so as to join the film to the container;
the container sealing apparatus being configured to move the container relative to the pressing member, such that a region of the container which is engaged by the pressing member changes.

By pressing a film into contact with a container, and applying a sealing beam (e.g. a laser) to the region of the film in contact with the container an effective seal may be achieved, regardless of imperfections or variations in surface of a container or film.

Moreover, controlling the relative movement between the containers and the pressing member (and the corresponding position of the sealing beam) enables the sealing of a variety of openings in different types of containers.

Therefore, the invention successfully offers an improved means of sealing containers with reduced energy consumption, greater flexibility, and potentially greater throughput than conventional heat sealing methods.

By “local” it will be understood that a sealing beam is applied at or adjacent to the pressing member, such that the film is in contact with or remains close to the container at the point at which the sealing beam is applied. As such, the sealing beam may pass close by or through the pressing member (where the pressing member comprises an aperture or is transparent to the sealing beam). For instance, the sealing beam source may be configured to emit one or more sealing beams which are incident on the container and/or the film within 2 cm of the pressing member, preferably within 1 cm of the pressing member.

It will be further appreciated that, in use, the film is positioned between the film and the container. Furthermore, it will be understood that the opposing sides of the film will be in contact with the container and the pressing member respectively within a region of the film and container that are engaged by the pressing member.

The apparatus may be configured to move the container, the pressing member, or both in order to create the relative movement. For instance, a container may be transported pasta pressing member which is in a fixed position. Equally a moving pressing member may pass across the surface of a stationary container. Moreover, the pressing member and the containers may each move. In each case, the relative movement results in different, laterally spaced portions of the container being engaged by the pressing member as the container is moved relative to the pressing member—i.e. the region of the container which is engaged by the pressing member changes. The relative movement between the pressing member and the container allows the container to be joined to the film at multiple locations around an opening so as to seal the container with the film (e.g. such that an opening in the container is surrounded by a continuous join between the film and the container).

A seal may be formed around the perimeters of opening(s) in the container by moving the container relative to the pressing member and operating the sealing beam source such that the sealing beam is made incident continuously or discretely around the perimeter of the opening(s). When the sealing beam is applied continuously a continuous seal or join may be formed along the path of relative movement between the sealing beam and the container and film (i.e. along the path which the sealing beam traverses relative to the container and the overlying film). Alternatively, when the sealing beam is applied discretely (e.g. periodically or separately) around an opening, a continuous join may be formed by adjacent or interconnected regions in which the film and container have been joined by the sealing beam.

The apparatus may be configured to join or bond the film to the container through polymer welding, in which the material of the film and/or container absorbs energy from the sealing beam and melts, thereby fusing the film and container together.

Additionally or alternatively, the film and container may be joined using an adhesive applied between the container and the film which is activated by energy from a sealing beam. For instance, the film and/or the container may comprise an adhesive coating. In such embodiments, the adhesive may be activated either directly as it absorbs energy from a sealing beam, or indirectly where the container material and/or film material absorb energy from a sealing beam and are heated up to activate the adhesive.

Packaging materials suitable in the containers discussed herein and with the sealing beams discussed below include—but are not restricted to—polypropylene (PP), polyethylene (PE), amorphous polyester terephthalate (A-PET), crystallized polyester terephthalate (C-PET), expanded polystyrene (EPS), aluminium foils, polystyrene (PS), polyvinyl chloride (PVC). In addition to these materials, the upper sealing face of a container may be coated with a low melting point polymer (e.g. polyethylene (PE)) to allow for easy sealing of the package. For instance, cardboard trays (or other containers) coated with a sealing polymer layer may be used.

Suitable film materials for sealing containers include both mono-layer and multi-layer films, which may be selected depending on the packaging performance required. Suitable film materials for use with the systems and methods discussed herein include polypropylene (PP) and polyethylene (PE). Where gas barrier properties are required, a film may be constructed with additional layers. For instance, in addition to polypropylene (PP) and/or polyethylene (PE), a layer of ethyl vinyl alcohol copolymer (EVOH) may be laminated into the film.

The film may be web-fed—i.e. provided to the container sealing apparatus as a continuous layer. Alternatively the film may be sheet-fed such that a container or a batch of containers is sealed by a sheet of film.

Where the sealing beam source is configured to emit multiple sealing beams these beam may be formed by splitting a beam emitted by a single beam source, or by using a plurality of beam sources.

The sealing beam(s)—the term “sealing beam(s)” being understood herein as meaning “sealing beam or sealing beams”—may be controlled to be incident on (i.e. to strike or impinge on) the container and/or film in a number of discrete, spaced locations. However, more preferably the sealing beam source is configured to control (i.e. vary or change) the position of one or more sealing beams relative to the container and/or the pressing member. For instance, the sealing beam source is preferably configured to move or change position of the one or more sealing beams, such that the position of the one or more sealing beams relative to the container and/or pressing member may be controlled (i.e. varied).

Preferably the sealing beam source is configured to join the film to the container along a path of relative movement between the container and a sealing beam of the one or more sealing beams. In other words, at least one sealing beam is scanned or traversed in a continuous manner across a surface of the container and/or film so as to cause a continuous join between the film and the container.

For instance, scanning mirrors or refractive optics can be used to precisely control the position of the sealing beam(s) (i.e. to vary the position of the sealing beam(s)) and therefore the energy input, allowing for increased geometric flexibility and throughput when compared with contact based processes. Additionally, joining the film and container during continuous motion of the substrate has the potential to significantly improve throughput times.

In some embodiments the apparatus comprises a transport system for transporting containers. Thus the containers may move relative to the pressing member. The transport system may be configured to transport containers through the container sealing apparatus past the pressing member and the sealing beam source. As such, the containers may be transported in a conveyance direction. In such embodiments the pressing member and the sealing beam source may be stationary but this is not essential. Preferably a transport system is configured to transport containers continuously through the container sealing apparatus to provide high throughput. In preferred examples the transport system may comprise a conveyor. For instance, a conveyor belt, a vacuum conveyor belt or rollers may be used.

Preferably the transport system is configured to transport containers through the container sealing apparatus with a consistent spacing between consecutive containers and/or with a consistent orientation. A consistent spacing or gap between containers and a consistent alignment simplifies control of the sealing beam(s) since the sealing beam may be operated over a predetermined path.

For instance, a transport system may comprise walls or guides to restrict or constrain the movement of the containers. Equally, a conveyor may comprise projections which engage with the containers, restricting their movement in the direction of travel. There is also potential for the inclusion of a vacuum conveyor belt system to ensure that the containers remain in place throughout conveyance.

Control of the sealing beams may be simplified if at least one side of the containers and/or at least one side of an opening are substantially parallel and/or perpendicular to the direction in which the container moves relative to the pressing member. However, this is not essential.

In alternative embodiments containers may be stationary during the sealing process and no transport system may be required (e.g. if the system is configured to move the pressing member and sealing beam). Equally in further embodiments the container sealing apparatus may be fed manually.

Additionally, or alternatively the apparatus may further comprise a sensor configured to determine the position and orientation of the container as the container moves relative to the pressing member, and wherein the sealing beam source is configured to control (i.e. vary) the position of a sealing beam of the one or more sealing beams based on the determined position and orientation of the container. Therefore, the sealing beams may be accurately applied to the perimeter of an opening or surrounding an opening to seal a container regardless of the initial orientation or position of the container. Furthermore such systems may be adapted for use with a wide variety of container shapes. Suitable sensors include a camera and infrared sensors.

In a particularly preferred embodiment the pressing member extends in a first direction across the path of the container relative to the pressing member and wherein the sealing beam source is configured to change the position of a sealing beam of the one or more sealing beams relative to the pressing member along a second direction parallel to the first direction.

Thus the sealing beam(s) may be moved along the second direction—i.e. along a scan line parallel to the direction in which the pressing member extends. For instance, the sealing beams may be controlled such that they move continuously along the second direction, or such that they are applied at a number of discrete points along the second direction.

Therefore, the sealing beam(s) (i.e. the sealing beam or the sealing beams) may be controlled to move relative to the pressing member so as to join a film to a container at multiple points local to the pressing member without changing the position of the pressing member. Furthermore, as the container moves relative to the pressing member the position of the sealing beam(s) may be varied to create a join along the path of relative movement. This join may (for instance) follow the perimeter of an opening in the container and/or extend around the rim of a tray or other container.

Preferably the sealing beam source is configured to emit one or more sealing beams to join the film to the container around the entire perimeter of an opening in the container. As such that the opening may be sealed by a join that surrounds the opening. Preferably such a seal is gastight and/or watertight. Such a seal is particularly beneficial when packaging food products since the products within containers are prevented from escaping and are kept fresh since they cannot interact with gases or liquids outside the container.

As the second direction in which the sealing beam(s) may be moved is parallel to the first direction in which the pressing member extends, the sealing beam(s) may be applied at a range of points which are the same distance from the pressing member. Consequently, the sealing beam(s) may be applied local to multiple parts or all parts of the pressing member which engage the container (i.e. where the pressing member is in contact with the container via the film). In other words, a successful join may be formed between the film and a container along the second direction along which the sealing beam may be moved, since at each point along the second direction the sealing beam will be incident on the film and/or container local to a part of the pressing member which contacts the film and engages the container.

Preferably the first direction in which the pressing member extends is angled with respect to the direction in which the container moves relative to the pressing member. Consequently the second direction along which the sealing beam(s) may be positioned is also angled with respect to the direction in which the container moves relative to the pressing member. In other words the first and second directions are preferably neither parallel nor perpendicular to the direction of movement of the container relative to the pressing member.

Angling the pressing member and the range of positions at which the sealing beam(s) may be applied in this manner enables containers to be easily and quickly sealed when the container moves continuously relative to the pressing member. A join which is parallel to the relative direction of movement between the container and the pressing may be formed by holding the sealing beam(s) at a constant location along the second direction as the sealing beam passes the pressing member. Equally, a join which is perpendicular to the relative direction of motion may be created by moving a sealing beam along the second direction such that the component of the sealing beam motion in the direction in which the container travels relative to the pressing member is equal to the speed at which the container travels in this direction.

Therefore, embodiments with angled pressing members are particularly suitable for examples in which the sides of containers and/or openings of containers are arranged parallel and/or perpendicular with the direction of relative movement between the containers and the pressing member (e.g. by a transport system).

In contrast, it is difficult to create a join which is perpendicular to a direction of relative movement if the pressing member and the scanline of the sealing beam(s) are arranged perpendicular to the direction of relative movement when containers move continuously relative to the pressing member and the scanline. This is because all points of the perpendicular path along which the sealing beam must travel will fall under the scanline of the sealing beams simultaneously. As such, a very short dwell time is available to create the desired join.

Preferably the angle between the first direction (and/or second direction) and the direction in which the container moves relative to the pressing member is in the range of 15 to 75 degrees, and preferably is in the range of 30 to 60 degrees, and more preferably is approximately 45 degrees.

An angle of 45 degrees is particularly beneficial since the rate of at which the beam moves in relative to the container is equal when forming a join parallel to the direction of relative movement (where the sealing beam(s) are held stationary in the second direction) and when forming a join perpendicular to the direction of relative movement (where the sealing beam(s) are moved along the second direction such that the component of the sealing beam(s) speed parallel to the direction of relative movement is equal to the rate at which the container moves relative to the pressing member along this direction). This is because at an angle of 45 degrees the components of the speed at which the sealing beam(s) are moved parallel and perpendicular to the direction of relative movement between the container and pressing member are equal. Therefore, joins with similar properties may be created in the parallel and perpendicular directions without the need to (for instance) vary the intensity of the sealing beam(s) or vary the speed at which the container moves to relative to the pressing member so as to maintain a constant dwell time. Hence effective seals may be easily created without affecting the throughput of containers.

Preferably the apparatus is configured to join the film to the container so as to form a seal around the entire perimeter of an opening in the container (i.e. such that the opening is surrounded by the seal). Preferably such a seal is gastight and/or watertight. Preferably the join between a container and film will have consistent properties around the perimeter of the opening in the container. Such a join simplifies the production of an effective seal since the join will be of similar strength around the entire perimeter of the opening.

The properties of the join depend in part on the amount of energy transferred to the container and film by the sealing beam. The energy transferred will depend on the power of the sealing beam and the dwell time of each portion of the container/film underneath the sealing beam.

In the examples discussed above in which the pressing member and scanline of the sealing beam extend across the relative path of the containers, the dwell time of a given region of the container and film will depend on the angle of the desired join relative to the scanline of the sealing beam (i.e. relative to the second direction along which the position of the sealing beam may be varied).

For instance, if the rim of a tray passes the pressing member and sealing beam source at a relatively acute angle to the scanline each portion of the rim will have a relatively large dwell time under the sealing beam when compared to a tray rim which passes the scanline perpendicularly. Assuming the speed of each tray relative to the pressing member and scanline is constant and the sealing beam is operated continuously at a constant power, the tray rim which passes the scanline at an acute angle will receive a larger amount of energy than the tray rim which is perpendicular. As such, the joins will be inconsistent. Where excessive energy is applied to the rim with an acute angle the container/film may be burnt, blackened or marked. Equally, the join between the tray and the film at the perpendicular rim may in some cases be too weak to acceptably seal an opening in the tray.

In view of these issues it will be appreciated that it may be difficult to provide a consistent join between container and film around the perimeter of an opening with curved sides and/or radiused or rounded corners.

To achieve an effective seal across such openings the sealing beam source may be configured to vary power of the sealing beam dependent on angle of the desired join relative to the scanline of the sealing beam (i.e. relative to the second direction, the second direction being a direction along which the position of the sealing beam may be varied). This angle may be detected as containers approach the pressing member using a sensor such as a camera and/or be pre-determined where containers travel relative to the pressing member and sealing beam source with a consistent orientation and periodicity (i.e. a consistent interval between containers). For instance, the sealing beam source may be configured to vary the power of the sealing beam as it traverses around the corner of an opening. In some embodiments the sealing beam source may be configured to increase the power of the sealing beam when applying (i.e. traversing) the sealing beam around a corner of the container, and/or to increase the power of the sealing beam to a maximum when applying (i.e. traversing) the sealing beam along a traverse path that is perpendicular or parallel to the second direction.

Thus the power of the sealing beam may be varied by the sealing beam source dependent on the portion of the container to be sealed. Preferably the power of the sealing beam is varied so as to maintain consistent energy per unit area around the perimeter of an opening as a container moves relative to the pressing member and sealing beam source.

In further embodiments the container sealing apparatus may be additionally or alternatively configured to vary the relative speed between the container and the pressing member so as to vary the dwell time of the sealing beam as it traverses around a corner or curve.

However, these features are not essential, and in further embodiments effective seals may be achieved by applying the sealing beam at a constant power and by using a constant relative speed between the container and the pressing member.

Preferably the pressing member is straight such that the first direction in which the pressing member extends is constant along the length of the pressing member. However, this is not essential and in other embodiments the pressing member and a parallel scanline along which the sealing beams are applied may be curved. In other words, the first and second directions discussed above may change along the length of the pressing member.

Preferably the width of the pressing member perpendicular to the direction in which the container moves relative to the pressing member is greater than the width of the container perpendicular to the direction in which the container moves relative to the pressing member. In other words, the pressing member may engage the container across the entire width of the container. Therefore, the container may be joined to the film at substantially any point across its width, and an opening in the container may be sealed around its entire perimeter in a single pass relative to the pressing member.

Preferably the sealing beam source is configured to emit a first sealing beam and a second sealing beam, and to control (i.e. vary or change) the position of the first sealing beam and second sealing beam such that the first sealing beam and second sealing beam move in opposing directions around the perimeter of an opening of the container. Thus a join can be formed which surrounds the opening so as to seal the opening of the container as the container moves continuously relative to the pressing member. Therefore, throughput may be increased. However, these features are not essential and in further examples a container may move past a single pressing member multiple times or past multiple pressing members sequentially.

Preferably, the pressing member is configured to press a film into contact with two containers simultaneously; and the sealing beam source is configured to emit at least one sealing beam incident on each container and/or the film, said sealing beams being incident local to a respective first part of the pressing member which engages each container so as to join the film to the containers; and the container sealing apparatus is configured to move the containers relative to the pressing member, such that the regions of each container that are engaged by the pressing member change.

Such embodiments of container sealing apparatuses may achieve further increases in throughput since they may join a film to multiple containers simultaneously. A line of containers may move sequentially (e.g. end-to-end) relative to the pressing member in the same direction. The pressing member of these embodiments may comprise any of the preferable features discussed above (e.g. the pressing member may extend in a direction which is angled with respect to the direction of relative movement between the containers and the pressing member).

Further embodiments are capable of sealing containers comprising two openings separated by a dividing portion. Such container sealing apparatuses may comprise: a pressing member configured to press film into contact with the dividing portion of the container; and, a sealing beam source configured to emit at least one sealing beam incident on the dividing portion and/or the film, said at least one sealing beam being incident local to a part of the pressing member which engages the dividing portion so as to join the film to the dividing portion. As such, a join may be formed along the dividing portion so as to prevent liquids and/or gases passing between the two openings.

In further preferred embodiments the container sealing apparatus may comprise a pressing member control system configured to move the pressing member, such that the pressing member may be moved relative to the container. For instance, the pressing member may be mounted on a robotic arm configured to control the position of the pressing member. Therefore, the pressing member may be moved to engage the container, pressing a firm into contact with the container, at a variety of locations across the surface of the container (e.g. to form a join which extends around or surrounds the opening of a container to seal the opening).

The container pressing member may be configured to control the position of the pressing member in at least two directions (e.g. along x- and y-axes, and/or in radial and circumferential axes). Thus the pressing member may be controlled to move in a plane that is parallel to the surface of a container to be sealed. In particularly preferred embodiments the sealing beam source is configured to control the position of a sealing beam such that the sealing beam moves with the pressing member relative to the container. Consequently, the relative positions of the pressing member and sealing beam are constant as the pressing member and the sealing beam move together relative to the container. Control of the path of the scanning beam may be achieved by scanning mirrors, refractive optics or other means. In alternative embodiments the sealing beam source may move with the pressing member but this is not essential.

Such embodiments may significantly simply control of the sealing beam. The apparatus (and the sealing beam source) may be configured to control the position of the pressing member and the sealing beam may be controlled such that the sealing beam is applied (i.e. traverses or moves across a surface of the container and/or film) around the entire perimeter of the opening with a consistent dwell time. Therefore, a consistent join and a successful seal can be reliably formed around the opening without modifying the power of the sealing beam.

For instance, in examples of an apparatus which comprise a transport system which conveys container(s) past the pressing member and the sealing beam source, the pressing member and sealing beam may be controlled to compensate for the movement of the container(s) in a conveyance direction. For example, the container, pressing member and sealing beam may be controlled to move at the same speed in a conveyance direction (i.e. such that there is no relative movement between the container, pressing member and sealing beam in the conveyance direction) when the sealing beam is being applied along a path which is parallel to the conveyance direction.

Therefore, the speed at which the sealing beam traverses the surface of the container or film, and therefore the dwell time at each point around the opening, is not linked to the speed at which trays are conveyed by the transport system. The sealing beam source may achieve a consistent dwell time (and a consistent level of energy applied to the container/film per unit area around the perimeter of an opening) whilst maintaining the power of the sealing beam at a constant level. As such, these apparatuses offer a simple means to provide consistent joins and more reliable seals.

Preferably the pressing member of these embodiments is annular, and the sealing beam source is configured to control the sealing beam such that the sealing beam passes through the central hole of the annular pressing member. As such, regardless of the direction in which the pressing member is moved relative to the container, the pressing member may press the film into contact with the container in advance of the path of the sealing beam. Moreover, the pressing member may press the film into contact with the container in an annular region surrounding the point at which the sealing beam is applied. This helps ensure that the film is in contact with the container at the position at which the sealing beam is incident on the container and/or film, thereby achieving an effective join and seal between the container and the film.

Preferably the sealing beam is a laser beam. For instance, the sealing beam may be a laser beam with a beam diameter of between 1 and 7 mm, preferably between 2 and 6 mm, and more preferably between 3 mm and 5 mm.

The inventors have had particular success with a Firestar 60W CO₂ laser produced by Synrad, Ltd.®. Such a laser system is commonly used for laser marking but has been found to be well suited for use in laser sealing of containers.

In a particularly successful embodiment the inventors have sealed film to trays and other containers by setting the laser power of the Firestar 60W CO₂ laser to 100% (60 W), and positioning the scanning head 289.0 mm above the seal point. In this arrangement the spot size or diameter of the sealing beam is approximately 2.6 mm. This spot size was confirmed experimentally by scanning a line into laser burn paper, estimating the width of the heat affected zone (HAZ) on either side of this scanned line using optical microscopy, and subtracting the heat affected zone from the total width of the marked line.

Alternatively the sealing beam source may be configured to emit alternative beams that are suitable for transmitting to transmit energy to the film and/or containers.

In further embodiments the container sealing apparatus may comprise a cutting system configured to separate sealed containers from the surrounding film.

Therefore, following the sealing process, the sealed containers may be separated or cut from excess film by the cutting system.

The cutting system could comprise a knife or other blade. However, preferably the cutting system may be configured to emit a cutting beam (e.g. a laser beam). Thus the cutting system comprises a cutting beam source configured to emit a cutting beam. This enables similar beam control optics to be used for the cutting beam as well as the sealing beam(s). Preferably the cutting system is configured to cut the film in alignment with or parallel to the perimeter of the containers.

In particular, the sealing beam(s) and cutting beam may be produced by identical beam sources but in which the cutting beam source is positioned nearer to the film than the sealing beam source, such that the cutting beam source is more tightly focused than the sealing beam source and has a higher power density. Using similar sources for the sealing and cutting beams simplifies maintenance and operation of the apparatus.

The cutting system and cutting beam source may be located downstream of the pressing member and the sealing beam source, to separate sealed containers from each other and surrounding film.

In alternative embodiments, the cutting beam source and the sealing beam source may be the same source, such that the sealing beam source also forms part of the cutting system. Consequently, the sealing beam source could be used both for sealing and cutting beams but with an appropriate increase in power density when undertaking the cutting process. Additionally or alternatively, the scan speed could be reduced using the sealing beam so as to provide more thermal energy to the film in order to cut the film.

In preferred embodiment of the system the containers to be sealed are supplied individually. However, it should be noted that there is potential for the containers to be supplied conjoined, to be separated by the cutting system during the cutting process.

Preferably the container sealing apparatus is suitable for sealing trays and the sealing beam source is configured to emit one or more sealing beams incident on the rim of a tray and/or film overlying the rim of a tray. Trays are a type of container commonly used in the food packaging industry having an upwardly facing opening. As such, the container sealing apparatus may be a tray sealer.

Preferably the pressing member comprises a flexible and resilient material. As such, the pressing member may be deformed when a force is applied (e.g. as it engages or presses firm into contact with a container) but will return to its original shape when the force is removed. Such a pressing member may achieve an effective join between a container and a film since the pressing member is capable of pressing the film into contact with a surface of the container regardless of changes in the position of the container surface.

Alternatively or additionally, the container sealing apparatus may comprise a biasing member which is configured to bias the pressing member into contact with a container as the container moves relative to the pressing member.

In further embodiments a surface of the pressing member configured to engage the container is angled towards the path of the container along the direction of relative movement between the container and the pressing member. This angling may ensure correct positioning of the film relative to the container, and can help accommodate variations in the position of a container surface relative to the pressing member (e.g. as may be cause by imperfections in the surface of a container).

According to a further aspect of the invention there is provided a container sealing apparatus comprising a plurality of sealing systems, each sealing system comprising:
a pressing member configured to press a film into contact with a container; and
a sealing beam source configured to emit one or more sealing beams, each of said sealing beams being incident on the container and/or the film local to a respective part of the pressing member which engages the container so as to join the film to the container;
wherein the container sealing apparatus is configured to move a line of containers relative to the pressing members and to alternately operate the plurality of sealing systems to seal consecutive containers along the line of containers.

Therefore, the plurality of sealing systems may be used to sequentially seal containers. For instance, in an example with two sealing systems a first sealing system may seal odd containers which pass through the container sealing apparatus (i.e. the first, third, fifth, etc. containers) and the second sealing system may seal the even containers which pass the container sealing apparatus (i.e. the second, fourth, sixth, etc. containers). This may be extended to examples which comprise three or more sealing systems.

Each of the plurality of sealing systems may comprise any of the features discussed above with respect to the first aspect of the invention. Such a container sealing apparatus may increase throughput since a single sealing system does not have to seal adjacent containers within a production line. This allows (for instance) gaps between containers may be reduced and/or the speed of a transport system to be increased.

According to a further aspect of the invention there is provided a method for sealing openings of containers with film, the method comprising:
pressing film into contact with a container using a pressing member;
operating a sealing beam source to emit one or more sealing beams, each of said sealing beams being incident on the container and/or the film, the sealing beam being incident local to a respective first part of the pressing member which engages the container so as to join the film to the container; and,
moving the container relative to the pressing member, such that a region of the container that is engaged by the pressing member changes; and
operating the sealing beam source to emit one or more sealing beams, each of said sealing beams being incident on the container and/or the film, the sealing beam being incident local to a respective second part of the pressing member which engages the container so as to join the film to the container.

Such a method offers an improved means of sealing containers with reduced energy consumption, greater flexibility, and potentially greater throughput than conventional heat sealing methods.

It will be appreciated that where the first and second parts of the pressing member are the same part of the pressing member there may be no relative movement between the pressing member and the sealing beam(s). Whereas where the first and second parts of the pressing member are different the sealing beam may have been moved relative to the pressing member.

Further features, advantages and modifications to this method are described above with respect to the first aspect of the invention which provides an apparatus suitable for performing methods according to this aspect of the invention.

Preferably the method further comprises controlling (i.e. varying) the position of a sealing beam of the one or more sealing beams relative to the container and/or the pressing member.

Preferably the method further comprises joining the film to the container along a path of relative movement between the container and a sealing beam of the one or more sealing beams.

Preferably the method further comprises transporting containers using a transport system.

Optionally the method further comprises transporting containers such that the containers have a consistent spacing and/or with a consistent orientation using the transport system.

In some embodiments the method comprises operating a sensor to determine the position and orientation of the container relative to the pressing member, and operating the sealing beam source to control (i.e. vary) the position of a sealing beam of the one or more sealing beams based on the determined position and orientation of the container.

In preferred embodiments the pressing member extends in a first direction, and the method further comprises controlling the sealing beam source to change the position of a sealing beam of the one or more sealing beams relative to the pressing member along a second direction parallel to the first direction.

Preferably the first direction in which the pressing member extends is angled with respect to the direction in which the container moves relative to the pressing member.

Preferably the angle between the first direction in which the pressing member extends and the direction in which the container moves relative to the pressing member is in the range of 15 to 75 degrees, and preferably is in the range of 30 to 60 degrees, and more preferably is approximately 45 degrees.

Preferably the width of the pressing member perpendicular to the direction in which the container moves relative to the pressing member is greater than the width of the container perpendicular to the direction in which the container moves relative to the pressing member

Optionally the method further comprises operating the sealing beam source to emit a first sealing beam and a second sealing beam, wherein the first sealing beam and second sealing beam move in opposing directions around the perimeter of an opening of the container.

Optionally the method further comprises the steps of:
pressing film into contact with two containers simultaneously using the pressing member;
operating the sealing beam source to emit at least one sealing beam incident on each container and/or the film over each container, each of said sealing beams being incident local to a respective part of the pressing member which engages the respective container so as to join the film to the respective container;
moving the containers relative to the pressing member, such that the regions of each container that are engaged by the pressing member change; and
operating a sealing beam source to emit one or more sealing beams, each of said sealing beams being incident on the second container and/or the film, the sealing beam being incident local to a respective second part of the pressing member which engages the containers so as to join the film to the containers;
wherein preferably the sealing beam source emits a third sealing beam and a fourth sealing beam, wherein the third sealing beam and fourth sealing beam move in opposing directions around the perimeter of an opening of the second container.

In some embodiments a container may comprise two openings separated by a dividing portion, and the method may further comprise the steps of:
pressing film into contact with the dividing portion using the pressing member; and,
operating the sealing beam to emit at least one sealing beam incident on the dividing portion and/or the film over the dividing portion, the sealing beam being incident local to a part of the pressing member which engages the dividing portion so as to join the film to the dividing portion.

Preferably the method further comprises moving the pressing member using a pressing member control system, such that the pressing member may be moved relative to the container.

Preferably the sealing beam source controls the position of a sealing beam such that the sealing beam moves with the pressing member relative to the container.

Preferably the pressing member is annular, and the sealing beam source controls the sealing beam such that the sealing beam passes through the central hole of the annular pressing member.

Preferably the sealing beam is a laser beam.

Preferably the method further comprises operating a cutting system to separate sealed containers from the surrounding film.

Preferably the method cutting beam source configured to emit a cutting beam.

Preferably the method is a method for sealing trays, in which the sealing beam source is operated to emit one or more sealing beams incident on the rim of a tray and/or film overlying the rim of trays.

Preferably the method comprises operating wherein the sealing beam source to emit one or more sealing beams which are incident on the container and/or the film within 2 cm of the pressing member, preferably within 1 cm of the pressing member.

Preferably the pressing member comprises a flexible and resilient material.

Preferably a surface of the pressing member configured to engage the container is angled towards the path of the container along the direction of relative movement between the container and the pressing member.

Preferably the method comprises the preceding step of filling the container with a food product before sealing the container. This is preferably preformed upstream of a container sealing apparatus. Such a method is suitable for providing an effective seal to the container, preventing liquids and gases entering or exiting the container, and preventing spoilage of the food product contained within.

In preferred examples the method may comprise the step of filling the containers with a purge gas before sealing the container. A purge gas may be inert or un-reactive with the contents of the container. For instance, with many food products the lifespan of the product may be increased by removing oxygen from a container prior to sealing the container. This may be achieved by performing the method in a controlled (e.g. oxygen free) environment.

Alternatively, or additionally the container sealing apparatus may be a closed system filled with a purge gas that is maintained at, or just above, atmospheric pressure. As containers pass through such a system the purge gas will fill the internal volume of the trays so as to evacuate oxygen and/or other atmospheric gases. This purge gas which is sealed in the container by the film is preferably inert and non-reactive with the packaged contents of the container. Purge gases which are heavier than air are particularly preferred as they will displace oxygen from a container which has an upwardly facing opening.

For instance, in low oxygen packaging nitrogen may be used to replace ambient air in a tray or other container to reduce levels of oxygen (e.g. to below 1%). This may slow the deterioration of food stuffs. Additionally or alternatively, carbon dioxide may be added to a tray to displace oxygen and slow the growth of bacteria. For instance, the atmosphere of a sealed food packaging container may comprise approximately 70% nitrogen, 30% carbon dioxide and 1% oxygen.

Alternatively, oxygen levels may be increased (e.g. to approximately 60% or higher) in high oxygen packaging. This is typically used when packaging red meats so as to maintain colour.

Preferably the method may be performed using the container sealing apparatus according to the first aspect of the invention, said container sealing apparatus including any of the preferable features discussed above.

According to a further aspect of the invention there is provided a method of sealing containers using the container sealing apparatus according to the second aspect of the invention discussed above. The method comprises comprising alternately operating the plurality of sealing systems to seal consecutive containers along the line of containers. The method may comprise any of the steps discussed above in relation to the preceding aspect of the invention.

### BRIEF DESCRIPTION OF DRAWINGS

FIGS. 1a, 1b and 1c show a cross section, plan view and projection view of a tray which may be sealed using apparatuses and methods according to embodiments of the invention.

FIG. 2 shows a schematic elevation view of a container sealing apparatus according to an embodiment of the invention.

FIGS. 3a to 3g respectively show sequential schematic plan views of a container sealing apparatus according to embodiments of the invention.

FIG. 4 shows a schematic plan view of a container sealing apparatus according to embodiments of the invention.

FIG. 5 shows a schematic plan view of a container sealing apparatus according to embodiments of the invention.

FIGS. 6a and 6b show examples of pressing members suitable for use in embodiments of the invention.

FIGS. 7a and 7b respectively show schematic elevation and plan views of a container sealing apparatus according to embodiments of the invention.

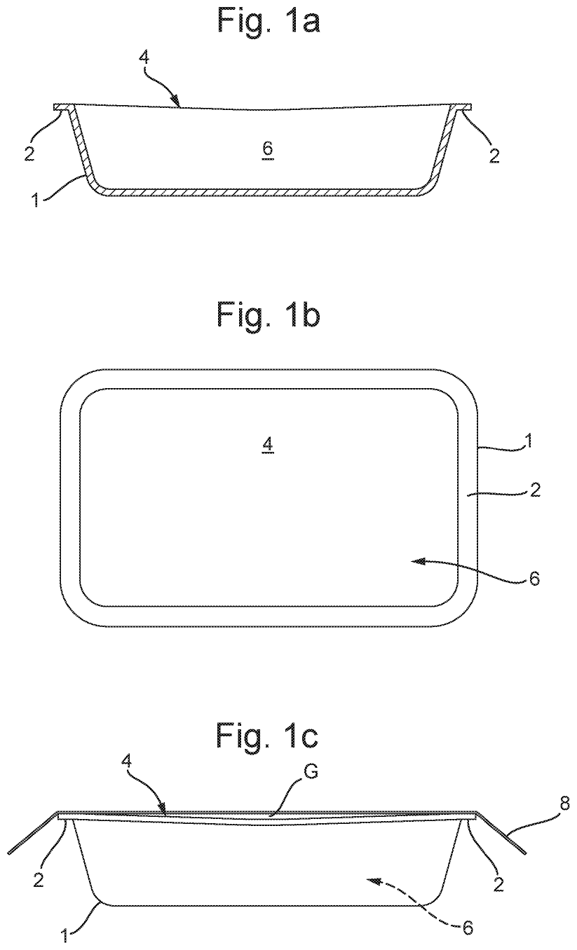

### DETAILED DESCRIPTION

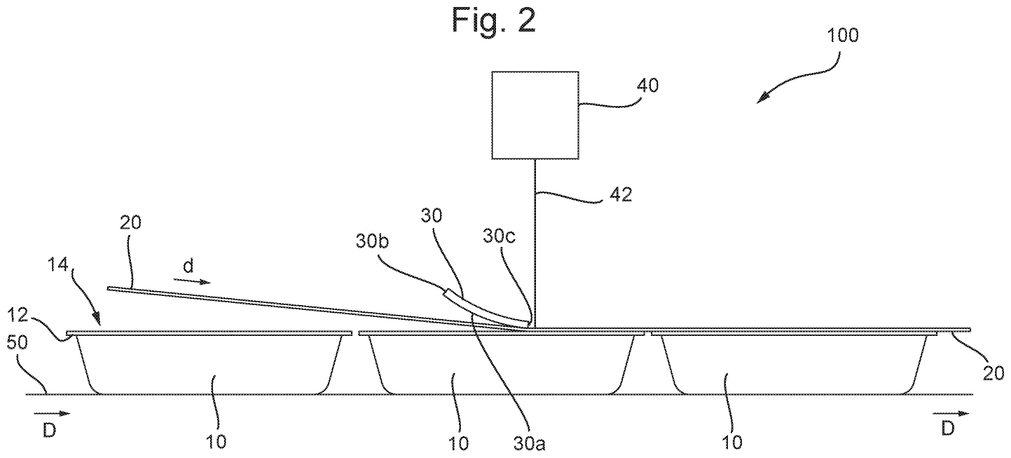

FIG. 2 shows schematically a container sealing apparatus 100 in cross section during the sealing of containers 10. These containers 10 comprise an upwardly facing opening 14 (such that the containers 10 are trays) surrounded by a rim 12.

The container sealing apparatus 100 comprises a pressing member 30, a sealing beam source 40 and a transport system 50. As shown, the transport system 50 (e.g. a conveyor) transports containers 10 in a direction D past the pressing member 30 and the sealing beam source 40. The pressing member 30 is positioned over the transport system 50 such that containers 10 travel or pass between the pressing member 30 and the transport system 50.

As shown, the container sealing apparatus 100 receives a web of film 20 which moves through the apparatus in direction d. The film 20 passes between the pressing member 30 and the containers 10.

As a container 10 and the film 20 pass between the pressing member 30 and the transport system 50, the pressing member 30 pushes the film 20 into contact with a container 10 (e.g. such that the pressing member 30 is in contact with the film 50, and the film 50 is in contact with the container 10 along a single line).

The sealing beam source 40 is arranged downstream of the pressing member 30 in direction D. To join the film 50 to the container 10, the sealing beam source 40 emits at least one sealing beam 42 suitable for joining a film 20 to the containers 10. The sealing beam(s) 42 are incident on the container 10 and/or the film 50 local to the pressing member 50 where the film 50 is in contact with the container 10. Consequently, the sealing beam(s) 42 join the film 50 to the container 10. For instance, the sealing beam(s) 42 may activate an adhesive present on the surface of the film 20 or the container 10, and/or melt the container 10 and/or the film 20 such that they are fused together.

The pressing member 30 may be formed of a flexible and resilient material such as rubber. As such, in use the pressing member 30 may be deformed into a curved shape, as shown in FIG. 2. As a resilient material, the pressing member 30 will is biased to return to its original shape, and therefore will continue to press film 20 into contact with the container 10 regardless of minor changes in the position of the rim 12 (e.g. as may be caused by imperfections in the surface of the container 10 or changes in the position of the transport system 50 on which the container 10 is supported). This helps ensure an effective join between the film 20 and container 10 regardless of changes in the position or shape of the container 10.

The surface 30a of the pressing member 30 which contacts the film 20 is angled towards the containers 10 (i.e. towards the path of the containers) in the direction of relative movement between the containers 10 and the pressing member 30 (i.e. along direction D). Specifically, a leading or upstream edge 30a of the pressing member 30 is positioned at a greater distance from the transport system 50 and the feed path of the containers 10 than the trailing or downstream edge of the pressing member 30. Consequently, the pressing member 30 accurately engages the film 20 and the containers 10, regardless in variations in the feeding of film 20 or the positioning of the film 20 and the containers 10. Again, this contributes to an effective seal around the opening of the containers 10, which avoids spills and prevents spoilage of packaged foods.

In the specific example shown in FIG. 2, the at least one sealing beam 42 passes adjacent to the pressing member 30, close to the trailing edge 30b of the pressing member 30 (i.e. the edge of the pressing member 30 further downstream in the direction of movement of containers 10 relative to the pressing member 30). This application of sealing beam(s) 42 local to the part of the pressing member 30 which engages the film 20 and the container 10 ensures an effective join since the film 20 remains in contact with or close to the surface of the container 10 where the sealing beam(s) 42 are incident.

In other embodiments, sealing beam(s) may be applied at other locations (e.g. upstream of the pressing member 30 in direction D). Alternatively, the pressing member may be configured to be transparent to the sealing beam(s) such that the sealing beam(s) may be transmitted through the pressing member 30 and be incident on the film 20 and/or container 10 whilst the pressing member 30 is in contact with the film 20.

As shown, the sealing beam source 40 is provided above the transport system 50 (i.e. such that the sealing beam source 40 is on the same side of the transport system as the pressing member 30 and the containers 10). However, in other embodiments a sealing beam source may alternatively or additionally be provided on the opposing side of the transport system 50 to the pressing member 30 (i.e. underneath the transport system 50 shown in FIG. 2). In such examples one or more sealing beams may be transmitted from the sealing beam source 40 through the transport system 50 before being incident on the film 20 and/or container 10. For instance, the sealing beam(s) may pass through an aperture in the transport system 50 or a portion of the transport system 50 which is transparent to the sealing beam(s).

The transport system 50 shown in FIG. 2 may be operated to transport the containers 10 continuously or discontinuously relative to the pressing member 30 and the sealing beam source 40. As the containers 10 move relative to the pressing member 30 the portion of the container 10 which is engaged by the pressing member 30 and the part of the container 10 and/or film at which the sealing beam 42 is incident changes. In other words, different, laterally spaced portions of the container 10 and film are engaged by the pressing member 30 as the container 10 is moved relative to the pressing member 30. Thus different parts of the container 10 may be joined to the film as may be necessary to seal around an opening in the container 10.

The speed of a transport system 50 may be determined, for instance, depending on the dwell time required to achieve a suitable join between the film 20 and the container 10. However, preferably the web of film 20 is fed to the container sealing apparatus 100 at a speed that is equal to the rate at which containers 10 are transported by the transport system 50 to avoid the web becoming slack or excessively taut. This helps avoid misfeeds, and acts to ensure an effective join between the container 10 and the film 20. In other embodiments each container 10 or a batch of containers 10 may be sealed with a single sheet of film (i.e. in a sheet-fed rather than web-fed process).

As shown in FIG. 2, the transport system 50 supplies containers 10 at consistent intervals (i.e. with a constant period between consecutive containers) and at a consistent orientation (e.g. such that each container transported by the transport system 50 is aligned with the remaining containers and preferably with the direction of movement). Such a regular and predictable transport of containers simplifies control of the sealing beam(s) 42 since the sealing beams(s) 42 may be operated in a consistent manner for each container. However, these features are not essential.

In further embodiments the system may comprise a sensor, such as a camera, configured to determine the position and orientation of containers as they move relative to the pressing member, and may be configured to control the sealing beam 42 based on the determined position and orientation of each container so as to accurately join the film to said container.

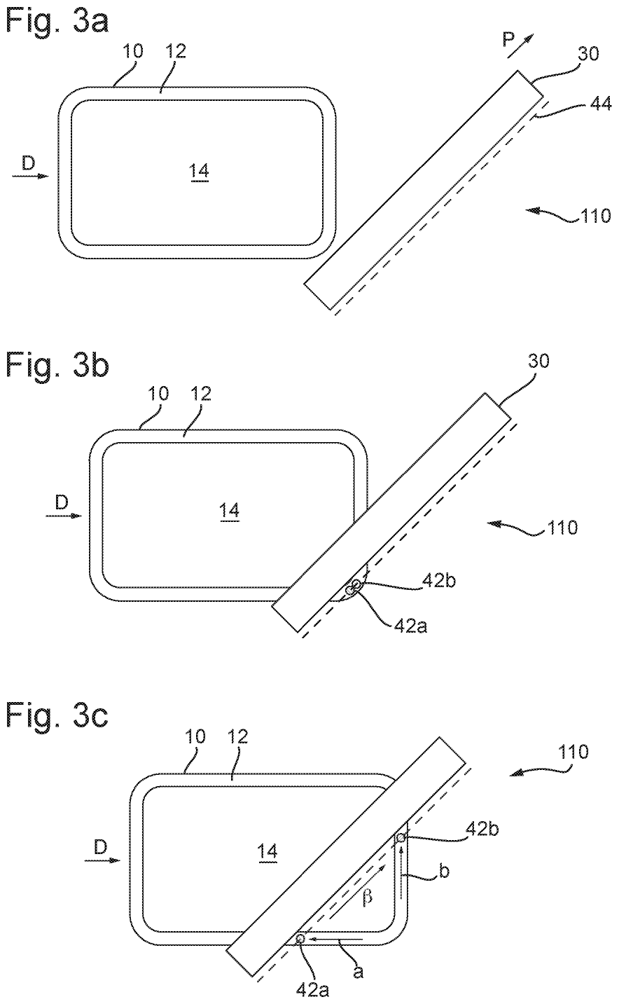

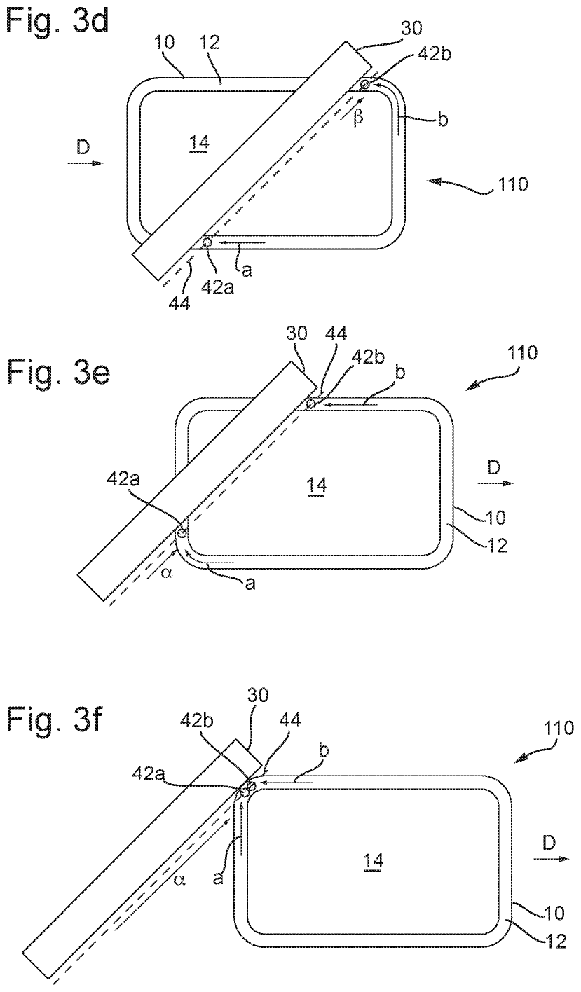

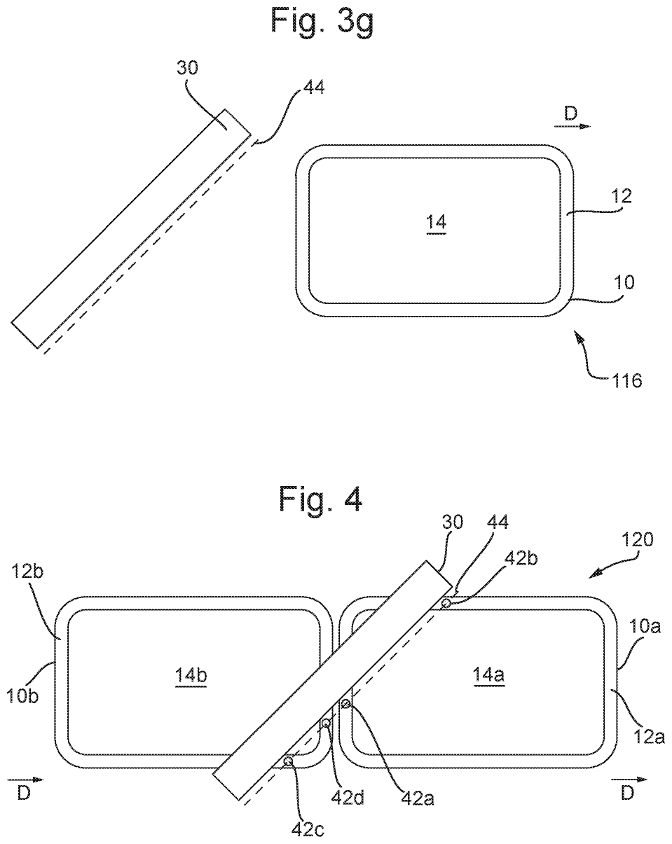

To fully seal around opening 14 the sealing beam(s) 42 may be operated to join the film 20 to the container 10 around the entire perimeter of the opening 14 (i.e. such that a join surrounds the opening 14). This may produce a gastight and watertight seal across the opening 14. An example of such a process and methods of operating a sealing beam source will now be discussed with reference to FIGS. 3a to 3g, in which corresponding features are provided with similar reference signs.

The method and apparatus which will be described below with reference to FIGS. 3a and 3g provides a simple and efficient means of sealing a container 10 (or other container) whilst the container 10 moves relative to a pressing member 30. In particular, sealing containers whilst they are continuously moving enables high throughputs as interruptions in the flow of containers 10 may be avoided.

FIGS. 3a to 3g show sequential images of a container sealing apparatus 110 in plan view as a container 10 (e.g. a tray) moves relative to a pressing member 30 in direction D. The container 10 is sealed by a film (not shown in these figures for ease of understanding).

The relative motion between the container 10 and the pressing member 30 may be achieved using a transport system configured to move the containers 10 (such as in FIG. 2), and/or a system configured to move the pressing member 30. As mentioned above, the relative movement is preferably continuous, and the speed of the relative movement is preferably equal to a feed rate of a web or sheet of film (not shown) used to seal the container 10.

As shown in FIG. 3a (where a container 10 and a film (not shown) approach the pressing member 30), the container 10 is substantially rectangular and comprises an opening 14 to an internal volume within which a product may be contained, the opening 14 being surrounded by a rim 12. To simplify control of a sealing beam source, the container 10 is orientated such that its long axis is parallel to the direction D of relative movement between the container 10 and the pressing member 30, and its short axis is perpendicular to this direction D of relative movement.

The pressing member 30 extends in a first direction P which is angled with respect to the direction D in which the container 10 moves relative to the pressing member 30 (i.e. such that the pressing member 30 extends in a direction is not substantially parallel or perpendicular to the path of the container relative to the pressing member 30). Specifically, the pressing member in FIGS. 3a to 3g is orientated at 45 degrees relative to the direction D in which the container 10 moves relative to the pressing member 30. The pressing member 30 is wider than the container 10 and may contact the rim 14 across the full width of the container 10.

The container sealing apparatus 110 further comprises a sealing beam source (not shown). The sealing beam source is configured to emit two sealing beams 42a, 42b. The sealing beam source is configured to control the position or path of each sealing beam 42a, 42b such that the position of each sealing beam 42a, 42b may be varied along a scan line 44 which extends parallel to the direction P in which the pressing member 30 extends. Consequently, the sealing beams 42a, 42b may be applied along a scan line 44 which is angled with respect to direction D of relative movement between the container 10 and the pressing member 30. The scan line 44 along which the sealing beams 42a, 42b may be moved is adjacent (i.e. local) to the pressing member 30.

As the container 10 travels relative to the pressing member 30 a film (not shown) positioned between the pressing member 30 and the container 10 will be pressed into contact with the container 10. Therefore, the sealing beams 42a, 42b may be applied to the film and/or the container 10 whilst they remain in contact, and before the film and container 10 have had an opportunity to move apart significantly. This ensures a successful join between the film and the container 10.

The sealing beam source is configured to control the two sealing beams 42a, 42b such that they travel in opposing directions around the perimeter of the opening 14 to the container 10. Furthermore, the sealing beam source is operated such that each sealing beam 42a, 42b moves relative to the container 10 the film will be joined to the container along each path of relative movement.

As shown, the sealing beam source controls the first sealing beam 42a to travel clockwise around the perimeter of the opening 14 and the second sealing beam 42b to travel anti-clockwise around the perimeter of the opening 14.

In these figures the movement of each sealing beam 42a, 42b is shown by two pairs of arrows. The first set of arrows represents the movement of the sealing beams 42a, 42b relative to the container (arrows a and b). Consequently, the first set of arrows a, b define the joins 46a, 46b formed between the film and the container by the first and second sealing beams 42a, 42b. The second set of arrows represents the movement of the sealing beams 42a, 42b along the scan line 44 and relative to the pressing member and sealing beam source (arrows α and β). Therefore, the second set of arrows α, β show the changes in position of the sealing beams 42a, 42b defined by the sealing beam source.

At FIG. 3b the container 10 and the film begin to pass the pressing member 30. The pressing member contacts the film, pressing the film into contact with container 10. The sealing beam source is operated to apply two sealing beams 42a, 42b at a corner of the rim 12 local or adjacent to the pressing member 30, thereby joining the film to the container 10.

As the container 10 continues to pass relative to the pressing member 30, the sealing beam source controls the positions of the first and second sealing beams 42a, 42b relative to the container 10 such that the first sealing beam 42a travels clockwise around the perimeter of the opening 14 and the second sealing beam 42b travels anti-clockwise around the perimeter of the opening 14. The sealing beams 42a, 42b meet at the corner of the container opposing the corner at which they started (as shown in FIG. 3f).

Consequently a continuous join is formed between the film and the container 10 around the entire rim 12 of the container 10. This join surrounds the opening 14 preventing liquids and gases from entering or leaving the container 10.

It will be appreciated that the sealing beams 42a, 42b may travel parallel to the direction D (i.e. the direction of relative motion between the container 10 and the pressing member 30) where the sealing beam source holds the position of the first sealing beam 42a constant. For instance, this may be seen between FIGS. 3b and 3c, and FIGS. 3c and 3d for the first sealing beam 42a, and between FIGS. 3d and 3e and FIGS. 3e and 3f for the second sealing beam 42b.

In these cases the sealing beams 42a, 42b do not move relative to the pressing member 30 and scan line 44. However, there remains relative movement between the container 10, and the pressing member 30 and sealing beam source in direction D. Thus the sealing beams 42a, 42b move parallel to this direction D relative to the container 10.

Equally, the sealing beams 42a, 42b may be controlled by the sealing beam source to move perpendicular to the direction of movement D relative to the container 10. Such motion can be seen between FIGS. 3b and 3c for the second sealing beam 42b and between FIGS. 3e and 3f for the first sealing beam 42a.

This movement is achieved where the sealing beam source moves the sealing beam along scan line 44 at a speed where the component of speed in direction D is equal the speed that the container 10 moves relative to the pressing member in direction D.

The movement of the sealing beams 42a, 42b relative to the container 10 around the corners of the container 10 may be achieved by varying the speed of at which the sealing beams 42a, 42b are moved along scan line 44 in comparison to the speed of the container 10 relative to the pressing member in direction D.

The sealing beam source may be configured to vary the power of the sealing beams 42a, 42b as the container 10 passes the scan line 44 to maintain a consistent join. This is because the dwell time of the sealing beams 42a, 42b on any portion of the rim will be determined by the speed at which containers 10 are conveyed past the scan line 44 and the angle of the traverse path of the sealing beams 42a, 42b (i.e. in this case the angle of rim 12) relative to the scan line 44. The sealing beam source may be configured to increase the power of the sealing beams 42a, 42b at the corners of the rim 12 to maintain consistent energy per unit area around the perimeter of the opening 14.

The throughput of containers through a packaging system containing a container sealing member as discussed above may be further increased by reducing the distance between the containers as they pass relative to the pressing member. Therefore, the rate at which containers are (for instance) transported by a transport system or engaged by the pressing member is increased.

However, when containers travel past the pressing member close to or adjacent to each other, multiple containers may be contacted by the pressing member simultaneously. This is especially likely where the pressing member is angled with respect to the direction in which a scan line of containers travel relative to a pressing member.

An example of this situation is shown in FIG. 4, which shows a container sealing apparatus 120 which is similar to the apparatus 110 discussed with reference to FIGS. 3a to 3g. Two containers 10a, 10b—which each comprise an opening 14a, 14b surrounded by a rim 12a, 12b—move sequentially in a scan line along a direction D relative to the pressing member 30 of a container sealing apparatus 120. The containers 10a, 10b are located substantially adjacent to one another such that the gap between them is small.

The containers 10a, 10b are aligned and orientated in the same direction to simplify the control of the sealing beams 42a, 42b, 42c, 42d. However, this is not essential.

As in FIGS. 3a to 3g, the pressing member 30 extends in a direction P which is angled with respect to the direction D of relative movement. Consequently, the containers 10a, 10b are each engaged by the pressing member 30 when the pressing member extends across the rear of the first container 10a and the front of the second container 10b.

A film is provided between the containers 10a, 10b, such that the pressing member 30 contacts the film and presses the film into contact with the rims 12a, 12b of each container 12a, 12b.

The container sealing apparatus 120 of FIG. 4 further comprises a sealing beam source configured to simultaneously emit four sealing beams 42a, 42b, 42c, 42d local to the pressing member 30. The sealing beam source is again configured to control the position of these sealing beams 42a, 42b, 42c, 42d along a scan line 44 which extends parallel to the direction P in which the pressing member 30 extends.

Initially, the sealing beam source is configured to emit a first sealing beam 42a and a second sealing beam 42b which may be made incident on first container 10a local to parts of the pressing member 30 which contacts the first container 10a. As the first container 10a moves past the pressing member 30, the sealing beams 42a, 42b may be controlled to move in opposing directions around the perimeter of the opening 14a of the first container 10a, thereby joining or connecting the film to the rim 12a of the first container 10 along the path of relative movement and sealing the opening 14a. This is analogous to the control the first and second sealing beams 42a, 42b discussed with reference to FIGS. 3a to 3g.

As the containers 10a, 10b continue to move relative to the pressing member 30 both the first and second containers 10a, 10b will be contacted by the pressing member 30 simultaneously and will each underlie the scan line 44 of the sealing beam source.

Therefore, the sealing beam source is further configured to emit a third sealing beam 42c and a fourth sealing beam 42d which are made incident on the rim 12b of the second container 10b. The third and fourth sealing beams 42c, 42d may be controlled to move in opposing directions around the perimeter of the opening 14b of the second container 10b to join or connect the film to the rim 14b of the second container 10b. Again this method of sealing the opening of the second container 10b is analogous to the control of the sealing beams discussed with reference to FIGS. 3a to 3g.

In other words, the sealing beam source is configured to emit sealing beams 42a, 42b, 42c, 42d incident on the containers 10a, 10b and/or the film overlying the containers 10a, 10b which are local to each point at which the pressing member 30 engages a container 10a, 10b. Therefore, the openings 14a, 14b of each container are sealed in a single pass of the containers 10a, 10b relative to the pressing member 30 and there is no requirement to perform subsequent sealing steps.

Therefore, the container sealing apparatus 120 which emits four sealing beams 42a, 42b, 42c, 42d is capable of efficiently sealing containers which are positioned close to each other as they are continuously transported relative to an angled pressing member 30.

Furthermore, the container sealing apparatuses 100, 110, 120 discussed above may also be modified to seal containers with multiple openings whilst the containers move continuously (i.e. during an in-line process).

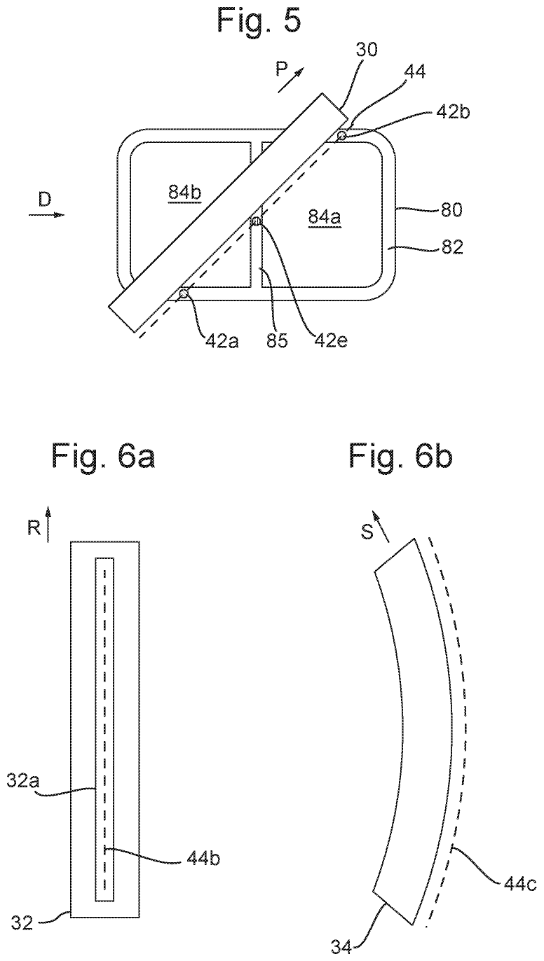

FIG. 5 shows a container sealing apparatus 130 capable of efficiently sealing containers 80 with two openings 84a, 84b separated by a dividing portion 85. The dividing portion 58 formed continuously with the outer rim 82 of the containers 80.

This container sealing apparatus 130 comprises a pressing member 30. The container 80 travels (preferably continuously) in a direction D relative to the pressing member 30. The pressing member 30 extends in a direction P which is angled relative to the direction D of relative movement (e.g. at an angle of 45 degrees). As the container 80 moves relative to the pressing member 30, the pressing member 30 contacts a film (not shown), pressing the film into contact with the rim 82 and dividing portion 85 of the container 80.

The container sealing apparatus 130 further comprises a sealing beam source 40 (not shown) configured to emit three sealing beams 42a, 42b, 42e along a scan line 44 which is parallel to direction P and local to the pressing member 30, such that the film is joined to the container 80.

As the container 80 moves relative to the pressing member 30, the sealing beam source 40 controls the position of the sealing beams 42a, 42b, 42e along the scan line 44. Consequently, the film pressed into contact with the container 80 is joined to the container 80 along the path of relative movement between the sealing beams 42a, 42b, 42e and the container 80.

Specifically, as in FIGS. 3a, to 3g, the sealing beam source is configured to control the first and second sealing beams 42a, 42b such that, relative to the container 100, they travel in opposing directions around the outer rim 82. The first sealing beam 42a travels clockwise around the perimeters of the first and second openings 84a, 84b. Whereas, the second sealing beam 42b travels anticlockwise around the perimeters of the first and second openings 84a, 84b. Thus, the first and second sealing beams 42a, 42b each form joins 46a, 46b as they move relative to the container 80, sealing the outer rim of the container 8 such that any product cannot escape through either opening 84a, 84b and such that the sealed opening may be watertight and/or gastight.

In contrast, the sealing beam source controls the position of the third sealing beam 42e such that the third sealing beam 42e moves relative to the container 80 along the dividing portion 125. Therefore, the third sealing beam 42e forms a join 46c along the dividing portion 125 of the container 80. This join 42e formed by the third sealing beam preferably connects the joins 42a 42b formed by the first and second sealing beams 42a, 42b. Therefore, the third sealing beam 42e seals the container 80 such that the first and second openings 84a, 84b cannot communicate (i.e. such that liquids and/or gases cannot pass between the two openings 84a, 84b across the seal).

Again the sealing beam source is configured to emit a sealing beam 42a, 42b, 42c incident on the container 100 and/or film overlying the container 80 local to each point of the pressing member 30 which engages the container 100 as the container 80 moves relative to the pressing member 30. Therefore, the openings 84a, 84b are sealed in a single pass of the pressing unit 30 relative to the container 80, there is no requirement to perform subsequent sealing steps.

It should be noted that—analogously to the example of FIG. 4—the sealing beam source discussed with reference to FIG. 5 may be configured to emit further sealing beams so as to seal multiple containers which are positioned close to each other and are simultaneously engaged by the pressing member 30 as the containers 80 travel relative to the pressing member. For instance, the sealing beam source may emit five or more sealing beams.

Additionally or alternatively, the apparatus 130 shown in FIG. 5 may be modified to seal containers with three or more openings. To achieve this, the sealing beam source may be configured to emit further sealing beams analogous to sealing beam 42e shown in FIG. 5 to seal any additional dividing portions which separate the additional openings.

The pressing member 30 in each of FIGS. 3a-3f, 4 and 5 is shown as a rectangular member which extends in a straight direction P. However, this is not essential. FIGS. 6a and 6b show alternative pressing members 32, 34 suitable for use in a container sealing apparatus

FIG. 6a shows a pressing member 32 which comprises an aperture 32a which is transparent to a sealing beam. For instance the aperture 32a may be a through hole, or formed of a material which is transparent to the sealing beam. The pressing member 32 and the aperture 32a extend linearly in direction R. A sealing member (not shown) may be configured to control one or more sealing beam(s) such that pass through the aperture 32a, and may be positioned along a scan line 44b which extends parallel to the direction R along the length of the aperture 32a.

Such a pressing member 32 may improve the effectiveness of the seal produced by the container sealing apparatus since a film may be pressed into contact with a container on either side of the location where a sealing beam is applied.

FIG. 6b shows a curved pressing member 34. The pressing member extends in the curved direction S. A sealing member (not shown) may be configured to control one or more sealing beam(s) such that the beam(s) may be positioned along a scan line 44c which extends parallel to the curved edge of the pressing member 34 such that the sealing beam is local to the pressing member 34 at each point along the scan line 44c.

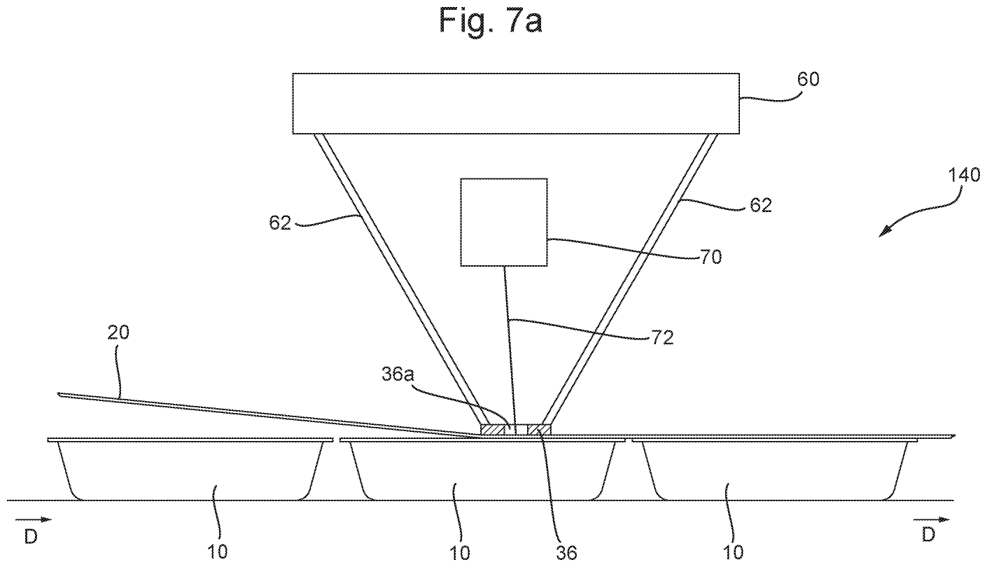

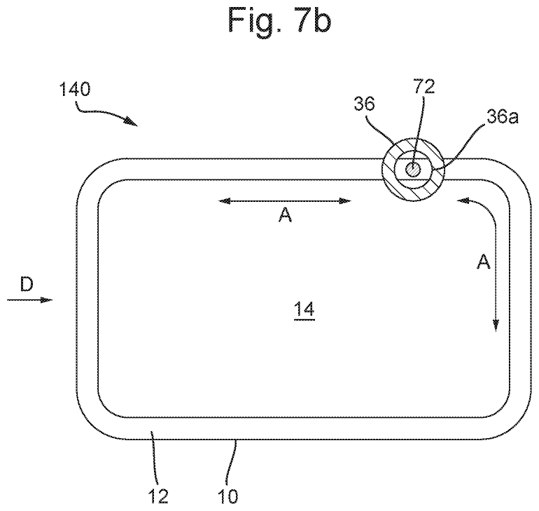

In the examples discussed above with reference to FIGS. 2 to 6b, the sealing beam(s) move relative to the pressing member. In contrast, FIG. 7a shows an alternative embodiment of a container sealing apparatus 140 in which a pressing member 150 and a sealing beam 72 move together relative to the container(s) (i.e. containers 10) to be sealed.

The container sealing apparatus 140 receives containers 10 and a web of film 20, as in the example of FIG. 2. A transport system 50 is configured to transport the containers 10 in a direction D. Preferably the containers 10 and film 20 are supplied at similar rates.

The container sealing apparatus 140 further comprises a pressing member 36 controlled by a robotic pressing member control system 60 which is configured to move the annular pressing member via arms 62. Suitable machines for the pressing member control system include parallel robots such as the Quattro product line manufactured by Omron®.

The container sealing apparatus 140 further comprises a sealing beam source 70 configured to emit a sealing beam 72. The sealing beam source 70 is configured to control the path of the sealing beam 72 (e.g. using mirrors or other optics) such that the sealing beam 72 moves with (i.e. in tandem with or in a corresponding manner to) the pressing member 36. Therefore, although the pressing member 36 and the sealing beam 72 may move relative to the containers 10 to be sealed they are controlled such that they not move relative to each other.

As shown, the web of film 20 passes between the pressing member 36 and the containers 10. The pressing member 36 pushes the film 20 into contact with each container 10 as the container 10 is transported past the pressing member.

The pressing member 36 is formed as an annulus, having a central aperture 36a which extends through the pressing member 36. To join the film 20 to each container 10 the sealing beam source 70 emits a sealing beam 72 through this aperture 36a such that the sealing beam 72 is incident on the container 10 and/or the overlying film 20. An effective bond is created since the film 20 is pressed into contact with the surface of the container 10 by the body of the pressing member 36 which surrounds the aperture 36a and the sealing beam 72 is applied local to (i.e. close to) this region of contact.

As shown in the schematic diagram of FIG. 7b (which shows a plan view of the container sealing apparatus 140 sealing a container 10, omitting the film 20, the pressing member control system 60, the sealing beam source 70, and the transport system) the pressing member control system 60 and sealing beam source 70 may control (i.e. vary) the position of the pressing member 36 and the sealing beam 72 such that they move together around the perimeter of the opening 14 in the container 10 (e.g. around the rim 12 of the container 10). Consequently the film 20 can be joined to the container 10 along the path of relative movement between the sealing beam 72 and the container 10.

The container sealing apparatus 140 may also comprise a sensor (e.g. a camera) positioned upstream of the pressing member 36 and sealing beam source 70 configured to detect the position and orientation of containers 10 (or other containers), such that the movement of the pressing member control system 60, the sealing beam source 70 may be controlled based on the position and orientation of the containers 10 detected by the sensor. Equally in further embodiments the container sealing apparatus 140 may not comprise a transport system 50, and instead the containers 10 may be supplied manually.

An annular pressing member 36 such as the one shown in is particularly suitable for use in examples of container sealing devices in which the sealing beam 72 and pressing member 36 move relative to the container to be sealed. Regardless of the direction in which the pressing member 36 and sealing beam 72 move relative to the container the film in advance of the sealing beam is pressed into contact with the container so as to achieve an effective seal. However, this is not essential and other shapes for the pressing member may be used successfully.

Each pressing member 36 may be formed of a flexible and resilient material such as rubber to accommodate changes in the position of a surface of the container 10 (e.g. due to imperfections in the rim 12 of the container).

The figures discussed above show containers supplied with consistent spacings, and which are orientated such that their sides (and dividing portions in the case of FIG. 5) are either parallel or perpendicular to direction D of movement between the pressing member and the containers. This can simplify control of the sealing beams (e.g. as they travel along a predetermined path), however, it is not essential.

For instance, the apparatus may be used with containers which have curved sides or dividing portions. Equally, the orientation of containers and the spacing between containers approaching the pressing member may vary. In such embodiments a sensor may be provided to detect the orientation and/or position of containers approaching the pressing member, and the sealing beam source may be configured to emit sealing beam(s) based on sensing results of the sensor. For instance, once the orientation and position of a container is determined, the sealing beam apparatus may determine an appropriate path for the sealing beam to seal an opening in the container (e.g. such that a join surrounds the opening) and the sealing beam source may control the sealing beam to follow the determined path.

In further examples the container sealing apparatuses described above may comprise a cutting system configured to separate sealed containers from the film, or use individual sheets of film for each container. This could be achieved using a knife or the like but it is particularly convenient if cutting is achieved using a second cutting beam.

To extend the shelf life of the contents of a sealed container, any of the apparatuses and methods described above may be implemented in a controlled atmosphere. For instance, the apparatus may be a closed system filled with a purge gas that is maintained at, or just above, atmospheric pressure. As containers pass through such a system the purge gas will fill the internal volume of the containers so as to evacuate air from within the containers. This purge gas which is sealed in the container by the film is preferably inert and non-reactive with the packaged contents of the container. In cases where low oxygen levels are desired, purge gases which are heavier than air (e.g. carbon dioxide) are particularly preferred as they will displace oxygen from a container which has an upwardly facing opening. Alternatively, oxygen may be used as a purge gas in high oxygen packaging.

1. A container sealing apparatus for sealing openings of containers with film, the container sealing apparatus comprising:
a pressing member configured to press a film into contact with a container; and
a sealing beam source configured to emit one or more sealing beams, each of said sealing beams being incident on the container and/or the film, each of said sealing beams being incident local to a respective part of the pressing member which engages the container so as to join the film to the container;
the container sealing apparatus being configured to move the container relative to the pressing member, such that a region of the container which is engaged by the pressing member changes.

2. A container sealing apparatus according to claim 1, wherein the sealing beam source is configured to control the position of a sealing beam of the one or more sealing beams relative to the container and/or the pressing member.

3. A container sealing apparatus according to claim 1, the sealing beam source being configured to join the film to the container along a path of relative movement between the container and a sealing beam of the one or more sealing beams.

4. A container sealing apparatus according to claim 1, further comprising a transport system for transporting containers.

5. A container sealing apparatus according to claim 4, wherein the transport system is configured to transport containers with a consistent spacing and/or with a consistent orientation.

6. A container sealing apparatus according to claim 1, further comprising a sensor configured to determine the position and orientation of the container relative to the pressing member, and wherein the sealing beam source is configured to control the position of a sealing beam of the one or more sealing beams based on the determined position and orientation of the container.

7. A container sealing apparatus according to claim 1, wherein the pressing member extends in a first direction, and wherein the sealing beam source is configured to change the position of a sealing beam of the one or more sealing beams relative to the pressing member along a second direction parallel to the first direction.

8. A container sealing apparatus according to claim 7, wherein the first direction in which the pressing member extends is angled with respect to the direction in which the container moves relative to the pressing member.

9. A container sealing apparatus according to claim 8, wherein the angle between the first direction in which the pressing member extends and the direction in which the container moves relative to the pressing member is in the range of 15 to 75 degrees, and preferably is in the range of 30 to 60 degrees, and more preferably is approximately 45 degrees.

10. A container sealing apparatus according to claim 7, wherein the width of the pressing member perpendicular to the direction in which the container moves relative to the pressing member is greater than the width of the container perpendicular to the direction in which the container moves relative to the pressing member.

11. A container sealing apparatus according to claim 7, wherein the sealing beam source is configured to emit a first sealing beam and a second sealing beam, and to control the position of the first sealing beam and second sealing beam such that the first sealing beam and second sealing beam move in opposing directions around the perimeter of an opening of the container.

12. (canceled)

13. (canceled)

14. A container sealing apparatus according to claim 1, wherein the container sealing apparatus further comprises a pressing member control system configured to move the pressing member, such that the pressing member may be moved relative to the container.

15. A container sealing apparatus according to claim 14, wherein the sealing beam source is configured to control the position of a sealing beam such that the sealing beam moves with the pressing member relative to the container.

16. A container sealing apparatus according to claim 14, wherein the pressing member is annular, and the sealing beam source is configured to control the sealing beam such that the sealing beam passes through the central hole of the annular pressing member.

17. (canceled)

18. A container sealing apparatus according to claim 1, further comprising a cutting system configured to separate sealed containers from the surrounding film.

19. (canceled)

20. (canceled)

21. A container sealing apparatus according to claim 1, wherein the sealing beam source is configured to emit one or more sealing beams which are incident on the container and/or the film within 2 cm of the pressing member, preferably within 1 cm of the pressing member.

22. A container sealing apparatus according to claim 1, wherein the pressing member comprises a flexible and resilient material.

23. A container sealing apparatus according to claim 1, wherein a surface of the pressing member configured to engage the container is angled towards the path of the container along the direction of relative movement between the container and the pressing member.

24. A container sealing apparatus comprising a plurality of sealing systems, each sealing system comprising:
a pressing member configured to press a film into contact with a container; and
a sealing beam source configured to emit one or more sealing beams, each of said sealing beams being incident on the container and/or the film, the sealing beam being incident local to a respective part of the pressing member which engages the container so as to join the film to the container;
wherein the container sealing apparatus is configured to move a line of containers relative to the pressing members and to alternately operate the plurality of sealing systems to seal consecutive containers along the line of containers.

25. A method for sealing openings of containers with film, the method comprising:
pressing film into contact with a container using a pressing member;
operating a sealing beam source to emit one or more sealing beams, each of said sealing beams being incident on the container and/or the film, the sealing beam being incident local to a respective first part of the pressing member which engages the container so as to join the film to the container; and,
moving the container relative to the pressing member, such that a region of the container that is engaged by the pressing member changes; and
operating the sealing beam source to emit one or more sealing beams, each of said sealing beams being incident on the container and/or the film, the sealing beam being incident local to a respective second part of the pressing member which engages the container so as to join the film to the container.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)
